(19) United States
(12) Patent Application Publication
(10) Pub. No.: US 2003/0234821 A1
(43) Pub. Date: Dec. 25, 2003

(54) Method and apparatus for the prediction of a text message input

(75) Inventor: Pierluigi Pugliese, Vaterstetten (DE)

Correspondence Address: HITT GAINES P.C., P.O. BOX 832570, RICHARDSON, TX, 75083, US

(73) Assignee: Agere Systems Inc., Allentown, PA

(21) Appl. No.: 10/378,953

(22) Filed: Mar. 4, 2003

(30) Foreign Application Priority Data
Mar. 25, 2002 (EP) 2006817.7

(51) Int. Cl. G06F 7/00

(52) U.S. Cl. 345/816; 455/566; 707/7

(57) ABSTRACT

The invention relates to a predictive word input method and apparatus. The method and apparatus provide predictive capabilities by finding a string or word that is related to other portions of the message. In one embodiment, the method for predicting a text message input includes matching an actually inputted letter sequence with stored words to search for at least one stored word that substantially matches a probability criterion of a word sequence.

### CROSS-REFERENCE TO FOREIGN APPLICATION

This application claims the benefit of EP Patent Application No. 02006817.7 entitled “Method and Apparatus for the Prediction of a Text Message Input” to Pierluigi Pugliese, filed on Mar. 25, 2002, which is incorporated herein by reference.

### TECHNICAL FIELD OF THE INVENTION

The present invention is directed, in general, to text messaging and, more specifically, to a method and apparatus for inputting text messages based on a predictive word input approach.

### BACKGROUND OF THE INVENTION

Predictive inputting of text is presently being used with some devices having keyboards. For example, when typing a text message such as a sort text message using a keyboard of a computer or user equipment (e.g., a mobile station) of a mobile radio network, it is possible to complete a word that is being typed by finding a possible match in a dictionary of the computer or user equipment. One existing predictive text input method is based on a multi-tap keyboard such as a keyboard wherein each key is reserved for a plurality of letters and a key is pressed more than one time to type a certain letter. For example, each key on a telephone keyboard has at least three letters, so that pressing of the number “5” could represent “J”, “K” or “L”. The predictive text input method replaces such conventional multi-tap text entry to enable users to compose text messages with only one key press per letter. This may be accomplished by automatically comparing the user's key presses to a linguistic database to provide the most commonly used word which can be written with the already pressed keys. A completion or a proposal for a completion of the word which is already partially typed by the user is not provided by this predictive text input method.

Another existing predictive text input method based on a conventional keyboard is to simply propose a stored word that begins with the letter or sequence of letters the user is actually typing. With this method, a proposal for a completion of the word which is already partially typed by the user is provided. The proposal, however, is not related to the last typed word or words.

In yet another existing method, last typed strings of a historic memory that begins with the characters or words the user has already typed are proposed. While this may be an effective way to retrieve certain last typed strings, the search for a string that best matches the argument of the preceding characters or words is not related to the last typed word or words of an actual text message.

Accordingly, what is needed in the art is a way to provide a predictive text input for improving prediction capabilities by finding a succeeding string or word that is related to the already typed portion of a text message.

### SUMMARY OF THE INVENTION

To address the above-discussed deficiencies of the prior art, the present invention provides a method for predicting a text message input and an apparatus employing the same. In one embodiment, the method for predicting a text message input includes matching an actually inputted letter sequence with stored words to search for at least one stored word that substantially matches a probability criterion of a word sequence.

By using such an inventive method, a letter sequence can be completed to a word regarding the last typed word or words of a text message which is already inputted by the user. Thus, the prediction capabilities are significantly improved. This is particularly true when inputting long text messages, since the longer the basis for the probability criterion, e.g., the word sequence already inputted of the text message, the more dependable or accurate is the probability criterion.

In a preferred embodiment, the probability criterion is calculated with regard to a matching possibility of a following word sequence and dependent on at least one classification criterion assigned to the word sequence previously inputted as the text message. This allows a simple look-up if the searched word is matching the classification criterion. Furthermore, the probability criterion is provided by searching the words previously inputted for the text message in, for instance, a the dictionary and retrieving argument codes additionally stored in conjunction therewith. As an example, the dictionary may employ memory to create a statistic of the argument codes used in the text message part already typed.

Accordingly, the principles of the present invention provide a dynamic way of providing a prediction since the statistic of the argument codes may be adapted continuously. In this respect and in an advantageous embodiment, a table is proposed to practically list the frequencies of occurrence of each of the arguments in decreasing or increasing order of frequency.

In the preferred embodiment, it is proposed to search in a dictionary the words beginning with the same character or characters. In accordance therewith, the method may retrieve for the words respectively assigned arguments codes for comparing with the table of frequencies such that the word having a respective argument code that is matching the argument code with the highest frequencies is represented.

In yet another aspect, the present invention provides an apparatus for use with a communications system. In one embodiment, the apparatus includes a means for typing a text message, a means for storing a plurality of words associated therewith and a means for matching an already inputted letter sequence with the means for storing to search for at least one word that substantially matches a probability criterion of a word sequence previously inputted.

In still yet another aspect, the present invention provides an apparatus for use with a communications system. In one embodiment, the apparatus includes a keyboard configured to input a text message and a processor unit, coupled to the keyboard, configured to communicate with a dictionary and a comparing device to match previously inputted letter sequence with stored words in the dictionary to search for at least one stored word that substantially matches a probability criterion of a word sequence.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a mobile phone constructed in accordance with the principles of the present invention.

### DETAILED DESCRIPTION

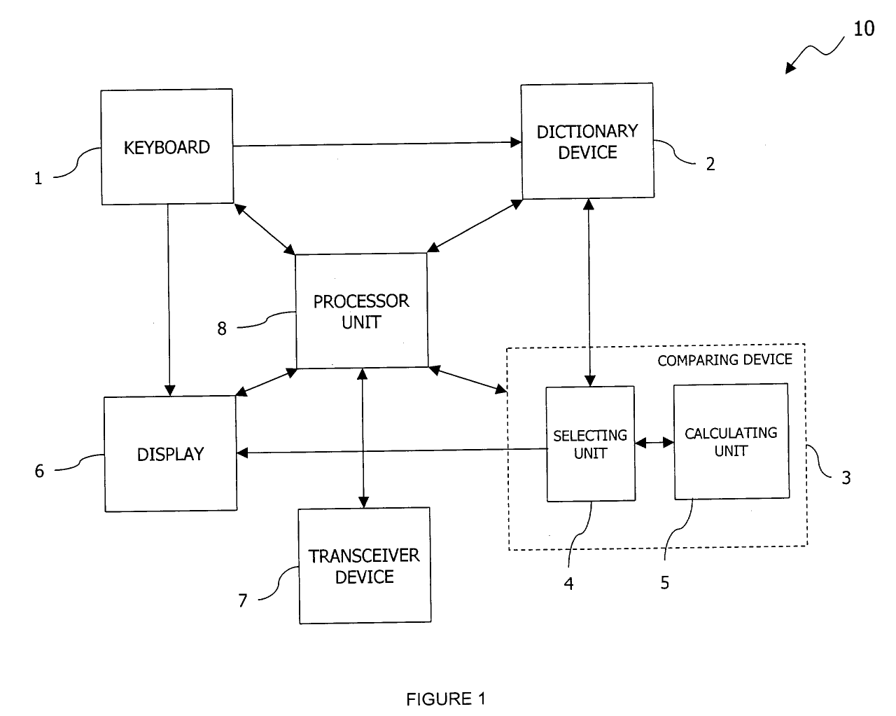

Referring initially to FIG. 1, illustrated is a block diagram of an embodiment of a mobile phone, generally designated 10, constructed in accordance with the principles of the present invention. The mobile phone 10 includes a keyboard 1, a dictionary device 2, a comparing device 3, a display 6, a transceiver device 7 and a processor unit 8. The comparing device 3 includes a selecting unit 4 and a calculating unit 5.

The mobile phone 10 may be configured to operate in a communications system such as a mobile radio network. Via the keyboard 1, a user may input a text message, such as a short message based on the short message service (SMS) provided by an operator of the mobile radio network. The text message or each character of a word typed in via the keyboard 1 (e.g., means for typing a text message) can be displayed on the display 6.

Once the entire text message has been typed in, the text message may be forwarded to the transceiver device 7 which embeds the text message into a respective signal format to send to a chosen target user equipment or to a group of target user equipments. This processing of the text message may be controlled by the processor unit 8 as indicated by the arrows originating and terminating at the processor unit 8. Preferably, the processor unit 8 monitors, controls or accesses a condition of each device involved in providing text messages.

According to an exemplary embodiment, the dictionary device 2 (e.g., means for sharing) of the mobile phone 10 may already have a plurality of stored words. Preferably, the processor unit 8 operates the dictionary device 2 to add and store additional words. Moreover, each word stored in the dictionary device 2 may have zero (0), one (1) or even more argument codes that are tagged or can be additionally tagged with argument codes by the user. The argument codes may be used as a classification criterion wherein the argument codes preferably identify arguments representing contents or subjects, such as news, sports, music, information, culture, greetings or fun, under which a respective word can be classified.

According to a preferred embodiment, argument codes that may be used as classification criterion may be initially stored in conjunction with the stored words. Consequently, in the dictionary device 2, there may also be words that are not tagged since these words may be too generic. The arguments assigned to the words by argument codes can be stored within the dictionary device 2 or in a another memory device which is connected with the dictionary device 2 such that the argument codes and the words are respectively linked by, for example, pointers.

In a preferred embodiment, the comparing device 3 (e.g., means for matching or comparing) may include the calculating unit 5 that is configured to calculate or provide a means for calculating a probability criterion dependent on the words already inputted for the text message and searched in the dictionary device 2. Argument codes additionally stored in conjunction with the already inputted words may be retrieved to create or provide a means for creating a statistic of arguments for the text message part already inputted. In some embodiments, argument codes respectively stored in conjunction with searched words may be compared with the probability criterion, so even when words have more than one argument code for classification, a matching comparison may be done by merely regarding the specific argument codes and not regarding the searched word itself.

In some embodiments, the dictionary device 2 or the comparing device 3 may be external to the mobile phone 10. For example, the dictionary device 2 or the comparing device 3 may be provided as a service of a network operator or may be embedded within other devices of an entire network. Additionally, a portion of the processing unit 8 or even an additional processing unit may be external to the mobile phone 10 to further assist predicting the text message. In these embodiments, the looking up of words in the dictionary device 2 (as a part of a means for searching) and/or the comparing of arguments in the comparing device 3 may be performed by transmitting or receiving corresponding control signals via the transceiver device 7. The transmission of the control signals may be either wireless as with the mobile phone 10 or hardwired as with, for example, a personal computer or terrestrial network based user equipment or telephone.

The selecting unit 4 may be configured to select or provide a means for selecting all words beginning with a same character or characters as the already inputted words by use of the keyboard 1 and searched in the dictionary device 2, so that the respectively retrieved assigned argument codes for the words can be compared with the probability criterion. For instance, the arguments codes may be compared with a table of frequencies to choose at least one word having a respective argument that matches the argument with a highest frequency.

Accordingly, when a user is typing a word of a text message by use of the keyboard 1, the processor unit 8 looks up in the dictionary device 2 for each typed character of the word all words beginning with the same character or characters to find matched words. Additionally, a code or codes of an assigned argument(s) of each of the matched words are retrieved. The matched words are then forwarded to the comparing device 3 and, in particular, to the selecting unit 4 for listing the matched words together with the argument codes assigned thereto.

A proposed word may be shown to the user via the display 6. The user may accept the proposed word by, for example, pressing a corresponding key of the keyboard 1. The user may ignore the proposed word by continuing to type other characters. Of course, one skilled in the art will understand that if-a word the user is typing is a first word of a text message, a table list of the calculating unit 5 is typically empty making the proposal of a specific word that can be displayed on the display 6 for the user difficult.

If the user has already typed at least one word, each already typed word is searched in the dictionary device 2 and the argument codes are retrieved. The already typed words and the argument codes may be forwarded to the calculating unit 5. The argument codes may be used to create a statistic of the arguments used in the text message part already typed. Thus, the frequencies of occurrence of each argument are listed in the table of frequencies in decreasing or even increasing order of frequency.

Thus, if at least one word of the text message is already typed in and the words beginning with the same characters with their assigned argument codes are retrieved the dictionary device 2 with their assigned argument codes retrieved, then the matching words forwarded to the selecting unit 4 can be compared with the frequency table dynamically stored in the calculating unit 5. As a result, the word or the words buffered in the selecting unit 4 that matches the argument with the highest frequency according to the table of frequencies of calculating unit 5 are proposed to the user and hence can be displayed on the display 6 as a proposal for completion. Accordingly, the longer the portions of a text message that are typed in, the better is the prediction capability with regard to the matching possibility of a following word and/or sequence of words.

Although the present invention has been described in detail, those skilled in the art should understand that they can make various changes, substitutions and alterations herein without departing from the spirit and scope of the invention in its broadest form.

What is claimed is:

1. A method for predicting a text message input, comprising:
matching an actually inputted letter sequence with stored words to search for at least one stored word that substantially matches a probability criterion of a word sequence previously inputted as part of the text message.

2. The method as recited in claim 1 further comprising calculating the probability criterion with regard to a matching possibility of a following word sequence dependent on at least one classification criterion assigned to the word sequence.

3. The method as recited in claim 1 further comprising storing in conjunction with at least some of the stored words at least one argument that can be used as a classification criterion.

4. The method as recited in claim 3 further comprising comparing at least one argument respectively stored in conjunction with the at least one stored word with the probability criterion.

5. The method as recited in claim 1 further comprising providing the probability criterion by searching in a dictionary the word sequence previously inputted as part of the text message and by retrieving arguments additionally stored in conjunction with the word sequence to create a statistic of arguments used in the word sequence.

6. The method as recited in claim 5 further comprising listing a frequency of occurrence of each of the argument in a table having an order selected from the group consisting of:
a decreasing order, and
an increasing order.

7. The method as recited in claim 5 further comprising:
finding matched words by searching in the dictionary for stored words beginning with the same characters as newly inputted characters;
retrieving assigned arguments for the matched words; and
comparing the assigned arguments with a table of frequencies, whereby the matched word having the assigned argument that is matching an argument with the highest frequency is presented.

8. The method as recited in claim 3 wherein subjects under which a respective word can be classified are chosen as being the arguments.

9. The method as recited in claim 9 wherein the arguments are subjects selected from a group consisting of:
news,
sports,
music,
information,
culture,
greetings, and
fun.

10. The method as recited in claim 1 wherein the method is embodied is a sequence of operating instructions.

11. An apparatus for use with a communications system comprising a means for typing a text message and a means for storing a plurality of words associated therewith, comprising:
means for matching an already inputted letter sequence with the means for storing to search for at least one word that substantially matches a probability criterion of a word sequence previously inputted.

12. The apparatus as recited in claim 11, further comprising:
means for calculating the probability criterion dependent on a selectable first word sequence with regard to the possibility of occurrence of a following second word sequence;
means for searching at least one stored word dependent on an initial letter sequence; and
means for selecting the one word of the searched words that substantially matches the probability criterion.

13. The apparatus as recited in claim 11 further comprising means for storing in conjunction with at least some of the stored words at least one argument that can be used as a classification criterion.

14. The apparatus as recited in claim 13 further comprising means for comparing the at least one argument with the probability criterion.

15. The apparatus as recited in claim 11 further comprising means for creating a statistic of arguments used in the text message part previously inputted by retrieving arguments additionally stored in conjunction with the words previously inputted for the text message.

16. The apparatus as recited in claim 15 wherein the means for creating is configured to list the frequencies of occurrence of each of the arguments in a table having an order selected from the group consisting of:
a decreasing order, and
an increasing order.

17. The apparatus as recited in claim 11 wherein the apparatus is embodied within a mobile phone.

18. An apparatus for use with a communications system, comprising:
a keyboard configured to input a text message; and
a processor unit, coupled to the keyboard, configured to communicate with a dictionary and a comparing device to match a previously inputted letter sequence with stored words in the dictionary to search for at least one stored word that substantially matches a probability criterion of a word sequence.

19. The apparatus as recited in claim 18 wherein at least one of the dictionary and the comparing device is separately located from the apparatus.

20. The apparatus as recited in claim 18 wherein the processing unit is further configured to communicate with an additional processing unit separately located from the apparatus to assist in the search.

21. The apparatus as recited in claim 18 wherein the word sequence is a previously inputted part of the text message.

22. The apparatus as recited in claim 18 wherein the apparatus is embodied within a mobile phone.
